(19) United States
(12) Patent Application Publication
(10) Pub. No.: US 2026/0039400 A1
(43) Pub. Date: Feb. 5, 2026

(54) ANTENNA HARDWARE TYPE TESTING AND INSTALLATION MANAGEMENT

(71) Applicant: Charter Communications Operating, LLC, St. Louis, MO (US)

(72) Inventors: Pareshkumar Panchal, Highlands Ranch, CO (US); Muhib Taiye Oduwaiye, Aurora, CO (US); Ramin Rohani, Denver, CO (US)

(21) Appl. No.: 18/790,957

(22) Filed: Jul. 31, 2024

(51) Int. Cl. H04B 17/12; H04B 17/00; H04B 17/14; H04B 17/24

(52) U.S. Cl. CPC H04B 17/12; H04B 17/0085; H04B 17/14; H04B 17/24

(57) ABSTRACT

A communication management resource as discussed herein receives antenna test information derived based on simultaneous transmission of a first wireless carrier frequency and a second wireless carrier frequency from each of multiple different types of antenna hardware. The communication management resource uses the antenna test information to determine wireless interference associated with each of the multiple different types of antenna hardware. The communication management resource then deploys the multiple different types of antenna hardware in a network environment based upon the determined wireless interference.

### BACKGROUND

Conventional wireless technology has been used for many years to connect wireless devices such as phones, laptops, etc., to a landline network and other wireless networks. For example, such wireless networks support many different types of connection services such as voice communications, cell communications, high-speed data services, Wi-Fi™ connectivity, and so on.

Cellular networks typically include a land area divided into so-called cellular regions. A single base station typically resides in each cell to provide wireless services. Often, the base station is connected to a landline network and supports communication with one or more wireless subscribers operating in a region covered by the cell. Accordingly, a wireless subscriber operating a cell phone in the cell is able to communicate with or have access to a landline network and remote network via a wireless link between the subscriber and a base station.

Many different types of antenna hardware are available to implement a respective base stations in a conventional cellular network. A performance associated with the different types of antenna hardware and corresponding cost of each may vary.

### BRIEF DESCRIPTION OF EXAMPLES

This disclosure includes the observation that, in a wireless communication system, antenna hardware is implemented in base station transmitters to achieve appropriate transmission gain (depending on antenna type, frequency band, tilt settings and more). Antenna gain may be the factor used to dimension the radio network after adding transmit power from the base station specifications in the form of EIRP (Equivalent Isotropic Radiated Power). It is noted that conventional antenna hardware may be directional to support beamforming or omni directional transmissions, depending on the type of requirement and business use case. It is typically desirable that information in given specification sheets associated with respective antennas match the corresponding performance of the antenna when deployed in the field.

In certain instances, the specifications (indicating expected performance) provided for a given type of antenna do not always match the performance of the corresponding antenna type in the field.

To provide better use of wireless resources in the network environment, techniques as discussed herein provide improved implementation of antenna hardware in wireless networks providing wireless services to respective wireless communication devices.

More specifically, a communication management resource as discussed herein receives antenna test information derived based on testing simultaneous transmission of a first wireless carrier frequency and a second wireless carrier frequency from each of multiple different types of antenna hardware. The communication management resource uses the antenna test information to determine wireless interference (i.e., wireless signal discrimination for each of one or more multiple wireless channels) associated with each of the multiple different types of antenna hardware transmitting the first wireless carrier frequency and the second wireless carrier frequency. Based upon the determined wireless interference, the communication management resource or other suitable entity configures a network environment with the multiple different types of antenna hardware. This may include deployment of the multiple different types of antenna hardware in one or more wireless base stations in the network environment.

In one example, the determined wireless interference for the multiple different types of antenna hardware is captured via so-called cross pole (cross polarization) discrimination information. In one example, cross-polarization discrimination, in dB (deciBels), is the difference between the peak of the co-polarized main beam and the maximum cross-polarized signal. In other words, the two signal components that determine cross-polarization discrimination are received on orthogonal polarizations. Higher (cross pole) signal discrimination for each tested wireless channel (or averaged for multiple wireless channels) supports lower interference amongst each of the wireless channels for the given antenna.

In further examples, in addition to the determined wireless interference, the communication management resource can be configured to receive cost information indicating a respective cost associated with each of the multiple different types of antenna hardware. Deployment of the different types of antenna hardware may depend on the respective cost associated with each of the different types of antenna hardware. For example, deploying the multiple different types of antenna hardware may include the communication management resource selecting amongst the multiple different types of antenna hardware to implement in a wireless base station based upon a combination of the respective cost and respective wireless interference (cross pole discrimination for one channel or multiple channels) associated with each the multiple different types of antenna hardware. Preferably, the cost of the antenna hardware is low along with the wireless interference amongst channels for the antenna hardware.

In further examples, the antenna test information captures wireless radiation patterns supported by the multiple different types of antenna hardware. In such an instance, deployment of the multiple different types of antenna hardware in the network environment includes the communication management resource (or other suitable entity): i) receiving installation criteria indicating desired wireless coverage to be provided by installation of a new wireless access point in a geographical region, and ii) based on applying the installation criteria to the wireless radiation patterns of the multiple different types of antenna hardware, selecting a first type of antenna hardware (such as providing appropriate signal discrimination) to implement the new wireless access point.

Note that the generated antenna test information can be configured to indicate detected wireless interference from multiple angular directions. For example, the use of the antenna test information to determine wireless interference may include the communication management resource: determining wireless interference associated with each of the multiple different types of antenna hardware for different angular directions.

As further discussed herein, deployment of the multiple different types of antenna hardware may include the communication management resource: selecting a first type of antenna hardware of the multiple different types of antenna hardware based on the determined wireless interference (such as cross pole discrimination); and implementing the first type of antenna hardware in a first wireless base station in the network environment.

The antenna test information can be configured to include first antenna test information associated with a first type of antenna hardware and second type of antenna hardware of the multiple different types of antenna hardware. Selection amongst the multiple different types of antenna hardware may include the communication management resource: i) selecting the first type of antenna hardware for implementing in the first wireless base station based on first wireless interference determined from the first antenna information, and ii) selecting the second type of antenna hardware for implementing in the wireless base station based on a second wireless interference determined from the second antenna information.

Yet further, the antenna test information can be configured to include first antenna test information derived from testing a first type of antenna hardware of the multiple different types of antenna hardware; the antenna test information can be configured to include second antenna test information derived from testing a second type of antenna hardware of the multiple different types of antenna hardware.

The first antenna test information and the second antenna test information can be configured to include any suitable measurements. For example, the first antenna test information can be configured to include first measurements generated by a receiver antenna simultaneously receiving the first wireless carrier frequency and the second wireless carrier frequency transmitted from the first type of antenna hardware; the second antenna test information can be configured to include second measurements generated by the receiver antenna simultaneously receiving the first wireless carrier frequency and the second wireless carrier frequency transmitted from the second type of antenna hardware.

In still further examples, the first measurements associated with the antenna test information are based on the receiver antenna simultaneously receiving the first wireless carrier frequency and the second wireless carrier frequency individually transmitted at multiple different angular directions from the first type of antenna hardware; the second measurements associated with the antenna test information are based on the receiver antenna receiving the first wireless carrier frequency and the second wireless carrier frequency transmitted at multiple different angular directions from the second type of antenna hardware.

Note that the examples as discussed herein are useful over conventional techniques. For example, implementation of a communication management resource and corresponding operations as discussed herein provide advanced analysis and more cost-effective deployment of different types of antenna hardware.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable hardware storage on which software instructions are encoded for subsequent execution. The computer-readable storage hardware for storing instructions may be configured as a non-transitory computer-readable storage medium. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on computer-readable storage hardware such as a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example herein includes computer-readable storage hardware and/or system having instructions stored thereon. The instructions, when executed by the computer processor hardware, cause the computer processor hardware (such as one or more co-located or disparately processor devices or hardware) to: receive antenna test information derived based on simultaneous transmission of a first wireless carrier frequency and a second wireless carrier frequency from each of multiple different types of antenna hardware; utilize the antenna test information to determine wireless interference associated with each of the multiple different types of antenna hardware; and deploy the multiple different types of antenna hardware in a network environment based upon the determined wireless interference.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity via efficient implementation of wireless base stations and corresponding different types of antenna hardware in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network management system supporting testing and implementation of multiple different types of antenna hardware as discussed herein.

FIG. 2 is an example diagram illustrating a test setup for testing each of multiple different types of antenna hardware as discussed herein.

FIG. 3 is an example diagram illustrating a test setup for testing each of multiple different types of antenna hardware as discussed herein.

FIG. 4A is an example diagram illustrating collection of co-pole field measurements (based on the test setup as in FIG. 2) as discussed herein.

FIG. 4B is an example diagram illustrating collection of cross-pole field measurements (based on the test setup as an FIG. 3) as discussed herein.

FIG. 5 is an example diagram illustrating a test setup for testing co-pole (a.k.a., co-polarization) field measurements for different types of antenna hardware simultaneously transmitting a first wireless carrier frequency and a second wireless carrier frequency in different directions as discussed herein.

FIG. 6 is an example diagram illustrating a test setup for testing cross-pole (a.k.a., cross-polarization) field measurements for different types of antenna hardware simultaneously transmitting a first wireless carrier frequency and a second wireless carrier frequency in different angular directions as discussed herein.

FIG. 7 is an example diagram illustrating co-pole field measurements and cross-pole field measurements collected for a first type of antenna hardware as discussed herein.

FIG. 8 is an example diagram illustrating co-pole field measurements and cross-pole field measurements collected for a second type of antenna hardware as discussed herein.

FIG. 9 is an example diagram illustrating generation of cross pole discrimination values (indicating individual cross pole discrimination values for each channel and average interference for multiple channels) for the first type of antenna hardware and the second type of antenna hardware as discussed herein.

FIG. 10 is an example graph illustrating a plot of cross pole the discrimination values versus angular sector as discussed herein.

FIG. 11A is an example diagram illustrating interference distribution associated with the first type of antenna hardware and the second type of antenna hardware as discussed herein.

FIG. 11B is an example diagram illustrating signal strength distribution associated with the first type of antenna hardware and the second type of antenna hardware as discussed herein.

FIG. 12 is an example flow chart illustrating operations of collecting co-pole and cross-pole field measurements and determination of cross pole discrimination (such as indicating interference) as discussed herein.

FIG. 13 is an example diagram illustrating receipt of first installation criteria and selection of one or more different types of antenna hardware to implement a corresponding wireless base station as discussed herein.

FIG. 14 is an example diagram illustrating receipt of second installation criteria and selection of one or more different types of antenna hardware to implement a corresponding wireless base station as discussed herein.

FIG. 15 is an example diagram illustrating example computer hardware and software operable to execute operations as discussed herein.

FIG. 16 is an example diagram illustrating a method as discussed herein.

The foregoing and other objects, features, and advantages of the invention (as described in the following examples) will be apparent from the following more particular description of preferred implementations herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

In one example as discussed herein, a management resource as discussed herein receives antenna test information derived based on simultaneous transmission of a first wireless carrier frequency and a second wireless carrier frequency from each of multiple different types of antenna hardware. The communication management resource uses the antenna test information to determine wireless interference (such as based on cross pole discrimination) associated with each of the multiple different types of antenna hardware. The communication management resource then deploys the multiple different types of antenna hardware in a network environment based upon the determined wireless interference.

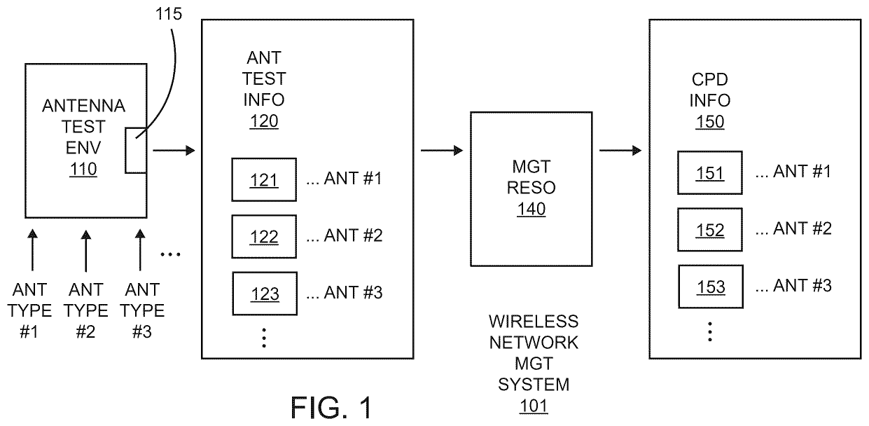

FIG. 1 is an example diagram illustrating a wireless network management system supporting testing and implementation of multiple different types of intent hardware discussed herein.

As shown in FIG. 1, the wireless network management system 101 includes antenna test environment 110 for testing multiple different types of antenna hardware (such as antenna hardware type #1, antenna hardware type #2, antenna hardware type #3, etc.) and corresponding management resource 140.

Each antenna hardware type includes a cross-polarization antenna and a co-polarization antenna. Antenna test environment 110 includes wireless signal analyzer 115 (such as a carrier frequency spectrum analyzer) to monitor and analyze wireless signals generated by each of the different instances of antenna hardware.

Note that each of the resources as discussed herein can be configured as hardware, software, or a combination of hardware and software. For example, the wireless signal analyzer 115 can be configured as wireless signal hardware, wireless signal software, or combination of wireless signal hardware and wireless signal software; the management resource 140 can be configured as management hardware, management software, or a combination of management hardware and management software; and so on.

As further shown, based on testing of each of the different type of antennas (antenna hardware), the signal analyzer 115 produces respective antenna test information 120. For example, the signal analyzer 115 produces the antenna test information 121 indicating attributes of receiving wireless signals from the antenna hardware type #1; the wireless signal analyzer 115 produces the antenna test information 122 indicating attributes of receiving wireless signals from the antenna hardware type #2; the wireless signal analyzer 115 produces the antenna test information 123 indicating attributes of receiving wireless signals from the antenna hardware type #3; and so on.

Note that the management resource 140 (such as communication management resource) can be configured to process the antenna test information 120 to produce respective interference information 150 (such as including interference information 151, interference information 152, interference information 153, etc.). In one example, the interference information is cross pole discrimination information.

More specifically, the management resource 140 derives the interference information 151 (cross pole discrimination) associated with testing the antenna hardware type #1 via processing of the antenna test information 121; the management resource 140 derives the interference information 152 (cross pole discrimination) associated with testing the antenna hardware type #2 via processing of the antenna test information 122; the management resource 140 derives the interference information 153 (cross pole discrimination) associated with the antenna hardware type #3 the processing of the antenna test information 123; and so on.

As further discussed herein, the interference information 151, 152, 153, etc., (wireless interference information 150) can be used as a basis in which to implement one or more instances of each of the different types of antenna hardware. For example, the interference information associated with each of the different types of antenna hardware provides an indication of cross all discrimination associated with transmitted wireless signals at each of the carrier frequency CF1 and the carrier frequency CF2.

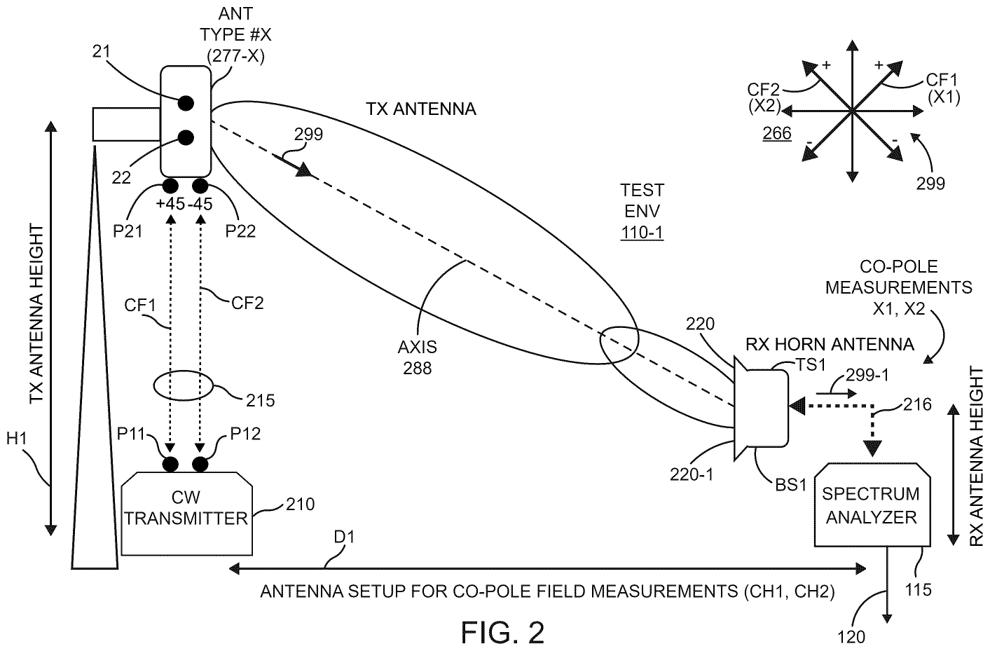

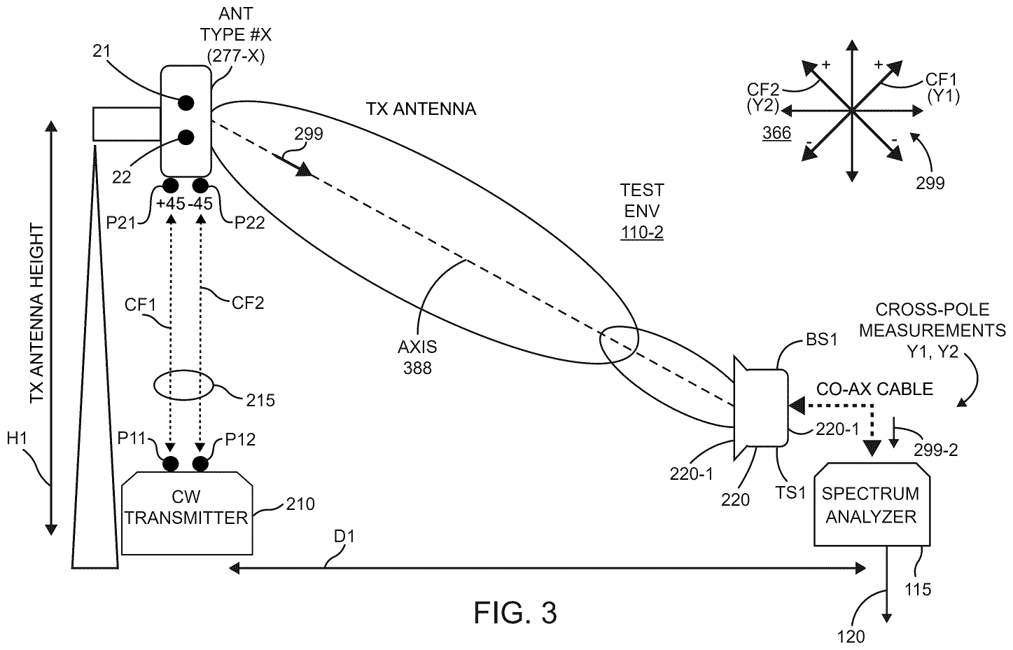

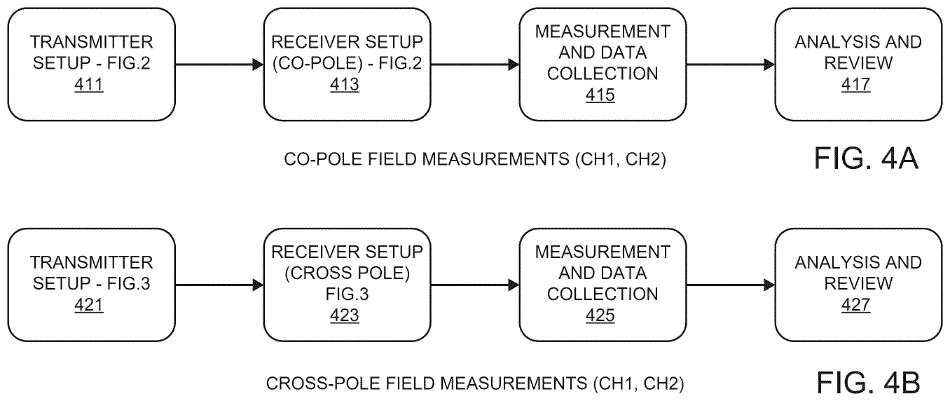

FIG. 2 is an example diagram illustrating a test setup for testing each of multiple different types of antenna hardware as discussed herein.

In this example, the antenna test environment 110-1 for obtaining co-polarization measurements includes the signal generator 210, antenna hardware under test type 277-X (antenna hardware type #X, where X=1 indicating antenna hardware type #1, where X equals 2 indicating antenna hardware type #2, where X equals 3 indicating antenna hardware type #3, and so on), receiver antenna 220 (such as a horn antenna or other suitable type of antenna), and signal analyzer 115 (spectrum analyzer).

Test environment 110-1 includes the receiver antenna hardware 220 oriented such that the top side TS1 of receiver antenna 220 is facing upwards and the bottom side BS1 of receiver antenna 220 is facing down. The receiver antenna tuner 20 receives wireless signals at the facing 220-1.

Axis 288 shows line-of-sight between the antenna under test 277-X and the receiver antenna 220. Graph 266 illustrates a view and corresponding orientation of the signals transmitted from each of the antenna components 21 and 22. More specifically, the antenna component 21 receives the signal CF1 and wirelessly transmits it at a +45 degree polarized orientation (wireless signal X1) as shown in the graph 266. The antenna component 22 receives the signal CF2 and wirelessly transmits it at a −45 degree polarized orientation (wireless signal X2) as shown in the graph 266. Accordingly, the wirelessly transmitted signal X1 is orthogonal to the wirelessly transmitted signal X2.

As further shown, the antenna test environment 110-1 further includes a physical cable 215 (such as coaxial cable or other suitable entity) providing connectivity between the signal generator 210 and the antenna under test type 277-X (such as antenna hardware type #1, antenna hardware type #2, antenna hardware type #3, etc.).

The antenna under test 277-X is disposed at a height H1 with respect to the signal generator 210 and ground.

Signal generator 210 includes multiple ports such as port P11 to output the carrier frequency signal CF1 (at a first carrier frequency or first channel CH1) to the port P21 (plus 45 degrees component) associated with the antenna under test 277-X.

Signal generator 210 includes the port P12 to output the carrier frequency signal CF2 (at a second carrier frequency or second channel CH2) to the port P22 (negative 45 degrees component) associated with the antenna under test 277-X.

In one example, the carrier frequency CF2 is adjacent to the carrier frequency CF1. The carrier frequencies CF1 and CF2 can be chosen from any suitable band such as a CBRS (Citizens Band Radio Service) or any other frequency band. The carrier frequency CF1 may be a first wireless channel selected from the CBRS band; the carrier frequency CF2 may be a second wireless channel selected from the CBRS band.

As an example of adjacency, the first wireless carrier frequency CF1 or bandwidth may be between 3.550 GHz and 3.560 GHz; the second wireless carrier frequency CF2 or bandwidth may be between 3.560 GHz and 3.570 GHz.

As further shown, the receiver antenna 220 of the test environment 110-1 is disposed at a distance D1 with respect to the base of the antenna hardware 277-X.

It is noted that the receiver antenna 220 includes a facing 220-1 to receive wireless signals. In the example antenna test environment 110-1 as shown in FIG. 2 for obtaining co-polarization measurements, the facing 220-1 of the receiver antenna 220 points in the direction to the antenna under test 277-X.

Yet further, based on the received signals such as first carrier frequency CF1 (at port P21) and second carrier frequency CF2 (at port P22), the antenna hardware under test 277-X (such as one of antenna hardware #1, antenna hardware type #2, antenna hardware type #3, etc.) outputs the wireless signals 299 (including transmission of combination of wireless carrier frequency CF1 and wireless carrier frequency CF2) in a direction towards the receiver 220.

The receiver antenna 220 converts the received wireless signals 299 into an electrical signal 299-1 conveyed over the respective cable 216 to the signal analyzer 115. The signal analyzer 115 measures magnitudes of the different components (such as +45 co-pole and −45 co-pole signals) associated with the received wireless signals 299 (as captured by wireless signal 299-1) to produce the antenna test information 120.

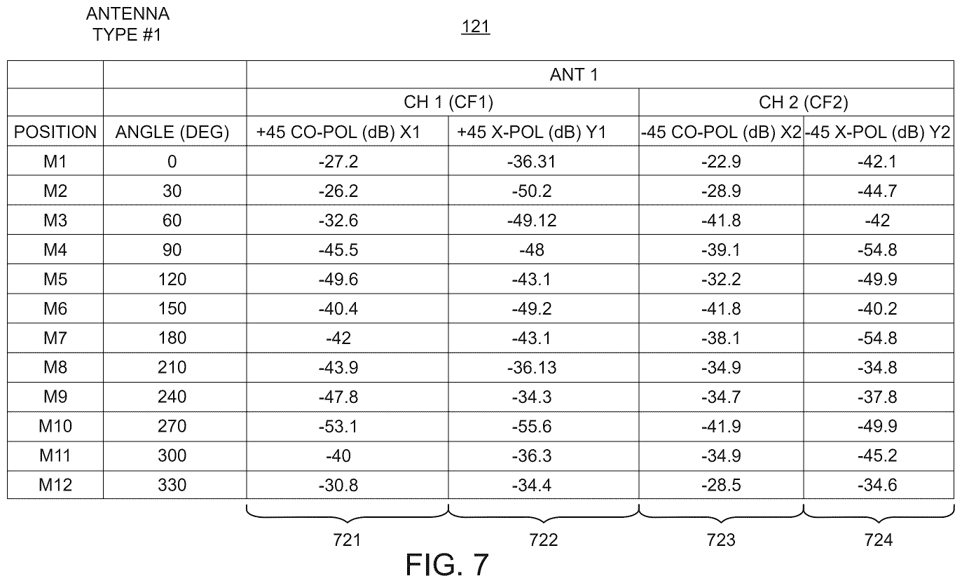

Based on the measurements of each of the different components (+45 co-pole measurement X1 for channel CF1 and −45 co-pole measurement X2 for channel CF2), the wireless signal analyzer 115 produces the respective antenna test information 121 and corresponding measurements for channel CF1 and channel CF2 as shown in FIG. 7 for antenna hardware type #1 for different angular directions. Column 721 in antenna test information 121 stores signal X1; column 723 in antenna test information 121 stores the signal X2 for each of the multiple test angles.

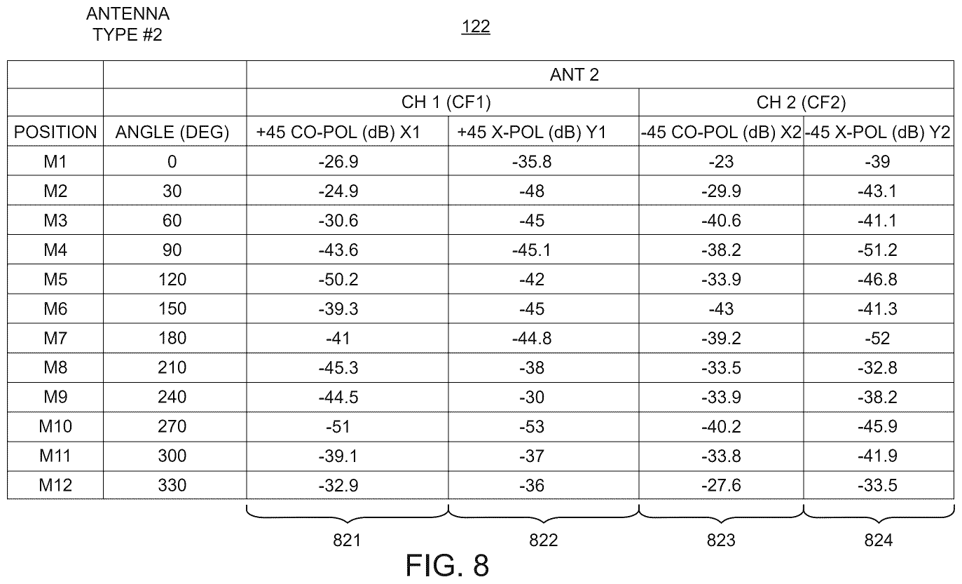

Based on the measurements of each of the different components (+45 co-pole measurement X1 for channel CF1 and −45 co-pole measurement X2 for channel CF2), the wireless signal analyzer 115 produces the respective antenna test information 122 and corresponding measurements for channel CF1 and channel CF2 as shown in FIG. 8 for antenna hardware type #2 for different angular directions. Column 821 in antenna test information 122 stores signal X1; column 823 in antenna test information 122 stores the signal X2 for each of the multiple test angles.

FIG. 3 is an example diagram illustrating a test setup for testing co-pole field measurements for each of multiple different types of antenna hardware simultaneously transmitting a first wireless carrier frequency and a second wireless carrier frequency as discussed herein.

In this example, the antenna test environment 110-2 includes the signal generator 210, antenna hardware under test type 277-X (antenna hardware type #X, where X=1 indicating antenna hardware type #1, where X equals 2 indicating antenna hardware type #2, where X equals 3 indicating antenna hardware type #3, and so on), receiver antenna 220 (such as a horn antenna or other suitable type of antenna), and wireless signal analyzer 115.

Test environment 110-2 includes the receiver antenna hardware 220 oriented such that the top side TS1 of receiver antenna 220 is facing down and the bottom side BS1 of receiver antenna 220 is facing up. This is opposite of the test environment 110-1. The facing 220-1 receives wireless signals from the antenna hardware 277-X.

Axis 388 shows line-of-sight between the antenna under test 277-X and the receiver antenna 220. Graph 366 illustrates a view and corresponding orientation of the signals transmitted from each of the antenna components 21 and 22 associated with the antenna hardware type under test 277-X. More specifically, the antenna component 21 receives the signal CF1 and wirelessly transmits it at a +45 degree polarized orientation (wireless signal Y1) as shown in the graph 366. The antenna component 22 receives the signal CF2 and wirelessly transmits it at a −45 degree polarized orientation (wireless signal Y2) as shown in the graph 266. Accordingly, the wirelessly transmitted signal Y1 is orthogonal to the wirelessly transmitted signal Y2.

As further shown, the antenna test environment 110-2 further includes a physical cable 215 (such as coaxial cable or other suitable entity) providing connectivity between the signal generator 210 and the antenna under test type 277-X (such as antenna hardware type #1, antenna hardware type #2, antenna hardware type #3, etc.).

When testing, the antenna under test 277-X is disposed at a height H1 with respect to the signal generator 210 and ground.

Signal generator 210 includes multiple ports such as port P11 to output the carrier frequency signal CF1 (at a first carrier frequency or first channel CH1) to the port P21 (plus 45 degrees) associated with the antenna under test 277-X.

Signal generator 210 includes the port P12 to output the carrier frequency signal CF2 (at a second carrier frequency or second channel CH2) to the port P22 (negative 45 degrees) associated with the antenna under test 277-X.

As previously discussed, the carrier frequencies CF1 and CF2 can be chosen from any suitable band such as a CBRS (Citizens Band Radio Service) or any other frequency band. In one example, the carrier frequency CF2 is adjacent to the carrier frequency CF1. The carrier frequency CF1 may be a first wireless channel selected from the CBRS band; the carrier frequency CF2 may be a second wireless channel selected from the CBRS band.

As more specific example of adjacency, the first wireless carrier frequency CF1 or bandwidth may be between 3.550 GHz and 3.560 GHz; the second wireless carrier frequency CF2 or bandwidth may be between 3.560 GHz and 3.570 GHz.

As further shown, the receiver antenna 220 of the test environment 110-2 is disposed at a distance D1 with respect to the base of the antenna hardware 277-X.

It is noted that the receiver antenna 220 includes a first facing 220-1 to receive wireless signals 299. In the example antenna test environment 110-2 as shown in FIG. 3, the receiver antenna 220 is flipped (180 degrees) upside down such that the top side TS1 of the receiver antenna 220 is on the bottom facing down and the bottom side BS1 of the receiver antenna 220 points in the upward direction. Accordingly, even though the receiver antenna 220 is flipped upside down, the facing 220-1 of the receiver antenna 220 still receives the wireless signals 299 from the antenna hardware 277-X under test.

Yet further, based on the received signals such as first carrier frequency CF1 (at port P21) and second carrier frequency CF2 (at port P22), the antenna hardware under test 277-X (such as one of antenna hardware #1, antenna hardware type #2, antenna hardware type #3, etc.) outputs the wireless signals 299 (including transmission of a combination of wireless carrier frequency CF1 and wireless carrier frequency CF2) in a direction towards the receiver 220.

The receiver antenna 220 converts the received wireless signals 299 into an electrical signal 299-2 transported over the respective cable 216 to the signal analyzer 115. The signal analyzer 115 measures magnitudes of the different components (such as +45 cross-pole and −45 cross-pole) associated with the received wireless signals 299 (as captured by wireless signal 299-2) to produce the antenna test information 120.

Based on the measurements of each of the different components (+45 cross-pole measurement Y1 for channel CF1 and −45 cross-pole measurement Y2 for channel CF2), the wireless signal analyzer 115 produces the respective antenna test information 121 and corresponding measurements for channel CF1 and channel CF2 as shown in FIG. 7 for antenna hardware type #1 for different angular directions. Column 722 in antenna test information 121 stores signal Y1; column 724 in antenna test information 121 stores the signal Y2 for each of the multiple test angles.

Based on the measurements of each of the different components (+45 cross-pole measurement Y1 for channel CF1 and −45 cross-pole measurement Y2 for channel CF2), the wireless signal analyzer 115 produces the respective antenna test information 122 and corresponding measurements for channel CF1 and channel CF2 as shown in FIG. 8 for antenna hardware type #2 for different angular directions. Column 822 in antenna test information 122 stores signal Y1; column 824 in antenna test information 221 stores the signal Y2 for each of the multiple test angles.

FIG. 4A is an example diagram illustrating collection of co-pole field measurements (FIG. 2) as discussed herein.

In this example, the wireless network management system 101 executes processing operation 411 and corresponding test environment 110-1 to test each of the different types of antenna hardware (transmitters) at different angular positions as discussed herein.

In processing operation 413, the wireless network management system 101 sets up the test environment 110-1 to receive wireless signals 299 via the receiver antenna hardware 220 and produce co-pole measurements X1 (+45 Co-pole) and X2 (−45 Co-pole) of wireless signals transmitted by the different types of antenna hardware at different angular positions.

In processing operation 415, the wireless network management system 101 measures signals X1 (+45 Co-pole) and X2 (−45 Co-pole) associated with wireless signals transmitted by the different types of antenna hardware at different angular positions to produce the antenna test information 120.

In processing operation 417, the wireless network management system 101 performs analysis and review of the respective antenna test information 120 to produce the antenna interference information 150 (capturing cross pole discrimination for each of first carrier frequency CF1 and the second carrier frequency CF2 and for each antenna hardware type).

FIG. 4B is an example diagram illustrating collection of cross-pole field measurements (FIG. 3) as discussed herein.

In this example, the wireless network management system 101 executes processing operation 421 and corresponding test environment 110-2 to test each of the different types of antenna hardware (transmitters) at different angular positions as discussed herein.

In processing operation 423, the wireless network management system 101 sets up the test environment 110-2 to receive wireless signals 299 via the receiver antenna hardware 220 and produce cross-pole measurements Y1 (+45 Cross-pole) and Y2 (−45 Cross-pole) of wireless signals transmitted by the different types of antenna hardware at different angular positions.

In processing operation 425, the wireless network management system 101 measures signals Y1 (+45 Cross-pole) and Y2 (−45 Cross-pole) associated with wireless signals transmitted by the different types of antenna hardware at different angular positions to produce the antenna test information 120.

In processing operation 427, the wireless network management system 101 performs analysis and review of the respective antenna test information 120 to produce the antenna interference information 150 (cross pole discrimination information for each of the first carrier frequency CF1 and the second carrier frequency CF2 for each different antenna type).

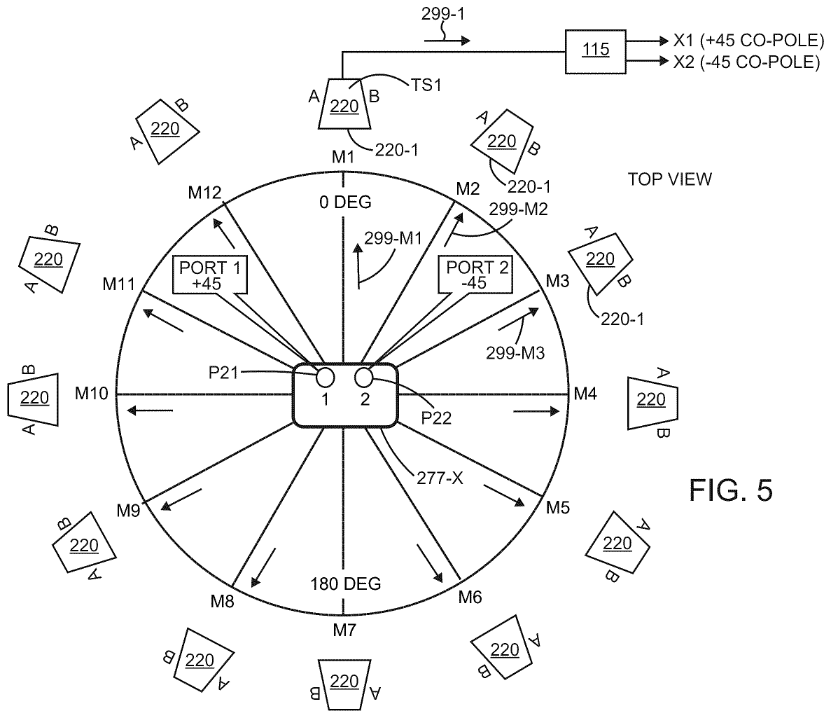

FIG. 5 is an example diagram illustrating a test setup for co-pole (a.k.a., co-polarization) field measurements X1 and X2 for a selected type of antenna hardware simultaneously transmitting a first wireless carrier frequency and a second wireless carrier frequency as discussed herein.

In this example, via test environment 110-1, the antenna under test 277-X is fixed. As shown, the receiver 220 is moved to the different locations to test the radiation pattern transmitted by the antenna under test 277-X. Reference values A (side A) and B (side B) indicate a top view orientation of the receiver antenna hardware 220. In one example, the front facing 220-1 of the receiver such as antenna horn is the main lobe direction of the horn antenna. From the top view, the topside TS1 of the antenna receiver 220 is in view.

Testing of the antenna hardware type #1 includes the antenna under test antenna hardware type #1 transmitting wireless signal 299-M1 (simultaneous transmission of carrier frequency CF1 signal and carrier frequency CF2 signal) in the 0 degree direction toward the front facing 220-1 of the receiver 220 (directional antenna). The receiver 220 converts the received wireless signal 299-M1 into a respective electrical signal 299-1 representative of the received wireless signal 299-M1 (including a representation of carrier frequency CF1 and carrier frequency CF2) received at the facing 220-1. The signal analyzer 115 such as a spectrum analyzer produces respective signal component X1 such as indicating a magnitude of the +45 co-pole component (−27.2 dB) of the received wireless signal 299-M1 and signal component X2 such as indicating a magnitude of the −45 co-pole component (−22.9 dB) of the received wireless signal 299-M1.

The antenna under test antenna type hardware #1 transmits wireless signal 299-M2 in the 30 degree direction toward the facing 220-1 of the receiver 220. The receiver 220 converts the received wireless signal 299-M2 into a respective electrical signal 299-1 representative of the received wireless signal 299-M2. The signal analyzer 115 such as a spectrum analyzer produces respective signal component X1 such as indicating a magnitude of the +45 co-pole component (−26.2 dB) of the received wireless signal 299-M1 and signal component X2 such as indicating a magnitude of the −45 co-pole component (−28.9 dB) of the received wireless signal 299-M2.

In this example, the antenna under test antenna type hardware #1 transmits wireless signal 299-M3 in the 60 degree direction toward the facing 220-1 of the receiver 220. The receiver 220 converts the received wireless signal 299-M3 into a respective electrical signal 299-1 representative of the received wireless signal 299-M3. The signal analyzer 115 such as a spectrum analyzer produces respective signal component X1 such as indicating a magnitude of the +45 co-pole component (−32.6 dB) of the received wireless signal 299-M3 and signal component X2 such as indicating a magnitude of the −45 co-pole component (−41.8 dB) of the received wireless signal 299-M3.

In a similar manner, that each of the different angular positions, the test environment 110-1 is used to produce the column 721 of data (component X1) and the column 723 of data (component X2) for antenna hardware type #1 as shown in FIG. 7

In this example, via test environment 110-1, the antenna under test antenna type #2 transmits wireless signal 299-M1 in the 0 degree direction toward the facing 220-1 of the receiver 220. The receiver 220 converts the received wireless signal 299-M1 into a respective electrical signal 299-1 representative of the received wireless signal 299-M1. The signal analyzer 115 such as a spectrum analyzer produces respective signal component X1 such as indicating a magnitude of the +45 co-pole component (−26.9 dB) of the received wireless signal 299-M1 and signal component X2 such as indicating a magnitude of the −45 co-pole component (−23 dB) of the received wireless signal 299-M1.

The antenna under test antenna type hardware #2 transmits wireless signal 299-M2 in the 30 degree direction toward the facing 220-1 of the receiver 220. The receiver 220 converts the received wireless signal 299-M2 into a respective electrical signal 299-1 representative of the received wireless signal 299-M2. The signal analyzer 115 such as a spectrum analyzer produces respective signal component X1 such as indicating a magnitude of the +45 co-pole component (−24.9 dB) of the received wireless signal 299-M1 and signal component X2 such as indicating a magnitude of the −45 co-pole component (−29.9 dB) of the received wireless signal 299-M2.

In this example, the antenna under test antenna type hardware #2 transmits wireless signal 299-M3 in the 60 degree direction toward the facing 220-1 of the receiver 220. The receiver 220 converts the received wireless signal 299-M3 into a respective electrical signal 299-1 representative of the received wireless signal 299-M3. The signal analyzer 115 such as a spectrum analyzer produces respective signal component X3 such as indicating a magnitude of the +45 co-pole component (−30.6 dB) of the received wireless signal 299-M3 and signal component X2 such as indicating a magnitude of the −45 co-pole component (−40.6 dB) of the received wireless signal 299-M3.

In a similar manner, for each of the different angular positions, the test environment 110-1 is used to produce the column 821 of data (component X1) and the column 823 of data (component X2) for antenna hardware type #2 as shown in FIG. 8.

Additionally, in this manner, each of the different types of antennas are tested.

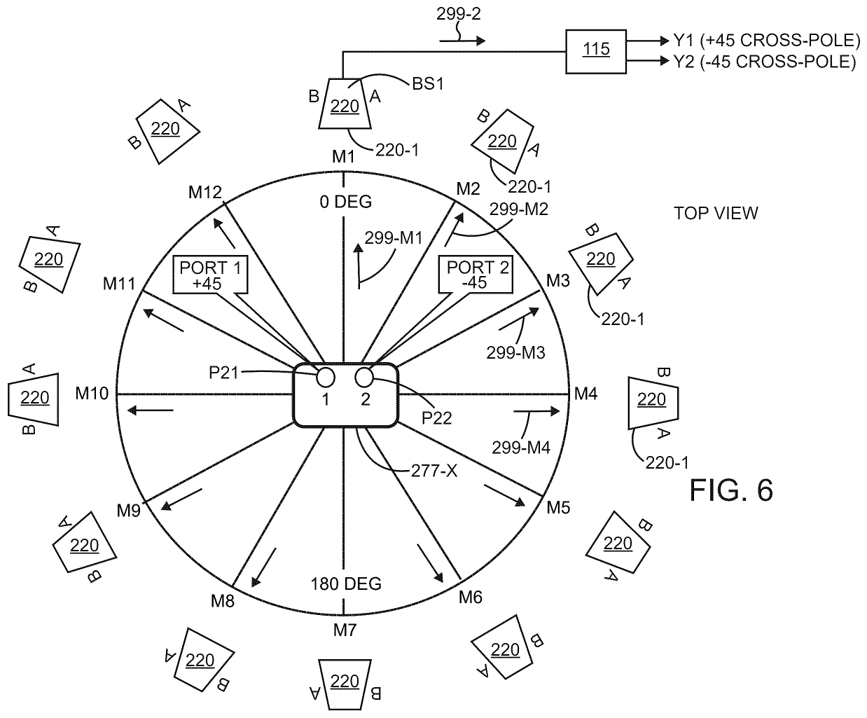

FIG. 6 is an example diagram illustrating a test setup for testing cross-pole (a.k.a., cross-polarization) field measurements for a selected type of antenna hardware simultaneously transmitting a first wireless carrier frequency and a second wireless carrier frequency as discussed herein.

In this example, via test environment 110-2, the antenna under test 277-X is fixed. The receiver 220 is moved to the different locations to test the radiation pattern transmitted by the antenna under test 277-X. Reference values B and A indicate a bottom view orientation of the receiver antenna hardware 220 shown from the top view. In other words, in test environment 110-2, the receiver 220 is flipped respect to the orientation of the receiver antenna in test environment 110-1. In one example, the front facing 220-1 of the receiver in time such as antenna horn is the main lobe direction of the horn antenna. From the top view, the bottom side BS1 of the antenna receiver 220 is in view.

In this example, via test environment 110-2, testing of the antenna hardware type #1 includes the antenna under test antenna hardware type #1 transmitting wireless signal 299-M1 (simultaneous transmission of carrier frequency CF1 signal and carrier frequency CF2 signal) in the 0 degree direction toward the facing 220-1 of the receiver 220. The receiver 220 converts the received wireless signal 299-M1 into a respective electrical signal 299-2 representative of the received wireless signal 299-M1. The signal analyzer 115 such as a spectrum analyzer produces respective signal component Y1 such as indicating a magnitude of the +45 cross-pole component (−36.31 dB) of the received wireless signal 299-M1 and signal component Y2 such as indicating a magnitude of the −45 cross-pole component (−42.1 dB) of the received wireless signal 299-M1.

The antenna under test antenna type hardware #1 transmits wireless signal 299-M2 (simultaneous transmission of carrier frequency CF1 signal and carrier frequency CF2 signal) in the 30 degree direction toward the facing 220-1 of the receiver 220. The receiver 220 converts the received wireless signal 299-M2 into a respective electrical signal 299-2 representative of the received wireless signal 299-M2. The signal analyzer 115 such as a spectrum analyzer produces respective signal component Y1 such as indicating a magnitude of the +45 cross-pole component (−50.2 dB) of the received wireless signal 299-M2 and signal component Y2 such as indicating a magnitude of the −45 cross-pole component (−44.7 dB) of the received wireless signal 299-M2.

The antenna under test antenna type hardware #1 transmits wireless signal 299-M3 (simultaneous transmission of carrier frequency CF1 signal and carrier frequency CF2 signal) in the 60 degree direction toward the facing 220-1 of the receiver 220. The receiver 220 converts the received wireless signal 299-M3 into a respective electrical signal 299-2 representative of the received wireless signal 299-M3. The signal analyzer 115 such as a spectrum analyzer produces respective signal component Y1 such as indicating a magnitude of the +45 cross-pole component (−49.12 dB) of the received wireless signal 299-M3 and signal component Y2 such as indicating a magnitude of the −45 cross-pole component (−42 dB) of the received wireless signal 299-M3.

In a similar manner, the test environment 110-2 is used to produce the column 722 of data (component Y1) and the column 724 (component Y2) of data as shown in FIG. 7.

Further in this example, via test environment 110-2, the antenna under test antenna type hardware #2 transmits wireless signal 299-M1 (simultaneous transmission of carrier frequency CF1 signal and carrier frequency CF2 signal) in the 0 degree direction toward the facing 220-1 of the receiver 220. The receiver 220 converts the received wireless signal 299-M1 into a respective electrical signal 299-2 representative of the received wireless signal 299-M1. The signal analyzer 115 such as a spectrum analyzer produces respective signal component Y1 such as indicating a magnitude of the +45 cross-pole component (−35.8 dB) of the received wireless signal 299-M1 and signal component Y2 such as indicating a magnitude of the −45 cross-pole component (−39 dB) of the received wireless signal 299-M1.

The antenna under test antenna type hardware #2 transmits wireless signal 299-M2 (simultaneous transmission of carrier frequency CF1 signal and carrier frequency CF2 signal) in the 30 degree direction toward the facing 220-1 of the receiver 220. The receiver 220 converts the received wireless signal 299-M2 into a respective electrical signal 299-2 representative of the received wireless signal 299-M2. The signal analyzer 115 such as a spectrum analyzer produces respective signal component Y1 such as indicating a magnitude of the +45 cross-pole component (−48 dB) of the received wireless signal 299-M2 and signal component Y2 such as indicating a magnitude of the −45 cross-pole component (−43.1 dB) of the received wireless signal 299-M2.

The antenna under test antenna type hardware #2 transmits wireless signal 299-M3 (simultaneous transmission of carrier frequency CF1 signal and carrier frequency CF2 signal) in the 0 degree direction toward the facing 220-1 of the receiver 220. The receiver 220 converts the received wireless signal 299-M3 into a respective electrical signal 299-2 representative of the received wireless signal 299-M3. The signal analyzer 115 such as a spectrum analyzer produces respective signal component Y1 such as indicating a magnitude of the +45 cross-pole component (−45 dB) of the received wireless signal 299-M3 and signal component Y2 such as indicating a magnitude of the −45 cross-pole component (−41.1 dB) of the received wireless signal 299-M3.

In a similar manner, the test environment 110-2 is used to produce the column 822 of data (component Y1) and the column 824 (component Y2) of data as shown in FIG. 8.

FIG. 7 is an example diagram illustrating co-pole field measurements and cross-pole field measurements collected for a first type of antenna hardware as discussed herein.

As previously discussed, the test environment 110-1 is used to collect the co-pole data (RSSI or Received Signal Strength Indicator indicating received wireless signal strength) such as component X1 in column 721 for channel CF1 and co-pole data (RSSI or Received Signal Strength Indicator indicating received wireless signal strength) such as component X2 in column 723 for channel CF2.

Further, as previously discussed, the test environment 110-2 is used to collect the cross-pole data (RSSI or Received Signal Strength Indicator indicating received wireless signal strength) such as component Y1 in column 722 for carrier frequency CF1 and data (RSSI or Received Signal Strength Indicator indicating received wireless signal strength) such as component Y2 in column 724 for channel CF2.

FIG. 8 is an example diagram illustrating co-pole field measurements and cross-pole field measurements collected for a second type of antenna hardware as discussed herein.

As previously discussed, the test environment 110-2 is used to collect the co-pole data (RSSI or Received Signal Strength Indicator indicating received wireless signal strength) such as component X1 in column 821 for carrier frequency CF1 and co-pole data (RSSI or Received Signal Strength Indicator indicating received wireless signal strength) such as component X2 in column 823 for carrier frequency CF2.

Further, as previously discussed, the test environment 110-2 is used to collect the cross-pole data (RSSI or Received Signal Strength Indicator indicating received wireless signal strength) such as component Y1 in column 822 for carrier frequency CF1 and cross-pole data (RSSI or Received Signal Strength Indicator indicating received wireless signal strength) such as component Y2 in column 824 for carrier frequency CF2.

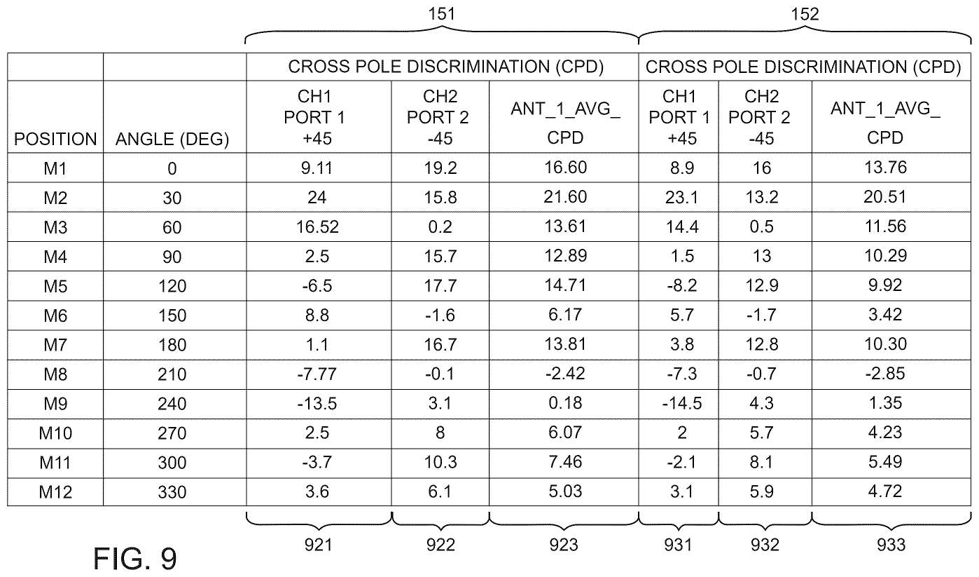

FIG. 9 is an example diagram illustrating generation of cross pole discrimination values for the first type of antenna hardware and the second type of antenna hardware as discussed herein.

As previously discussed, the communication management resource 140 uses the antenna test information 121 associated with the antenna hardware type #1 in FIG. 7 to produce the interference information 151 (indicating a degree of cross pole discrimination between carrier frequency CF1 and carrier frequency CF2) in FIG. 9.

The communication management resource 141 produces the column 921 based on the difference between component X1 in column 721 and the component Y1 in column 722 for each of the angular positions M1 through M12. Accordingly, the communication management resource 140 produces the value 9.11 for the angular position M1 based on a difference between −27.2 dB and −36.31 dB; the communication management resource 140 produces the value 24 for the angular position M2 based on a difference between −26.2 dB and −50.2 dB; the communication management resource 140 produces the value 16.52 for the angular position M3 based on a difference between −32.6 dB and −49.12 dB; the communication management resource 140 produces the value 2.5 for the angular position M4 based on a difference between −45.5 dB and −48 dB; and so on.

The communication management resource 141 produces the column 922 based on the difference between component X2 in column 723 and the component Y2 in column 724 for each of the angular positions M1 through M12. Accordingly, the communication management resource 140 produces the value 19.2 for the angular position M1 based on a difference between −22.9 dB and −42.1 dB; the communication management resource 140 produces the value 15.8 for the angular position M2 based on a difference between −28.9 dB and −44.7 dB; the communication management resource 140 produces the value 0.2 for the angular position M3 based on a difference between −41.8 dB and −42 dB; the communication management resource 140 produces the value 15.7 for the angular position M4 based on a difference between −39.1 dB and −54.8 dB; and so on.

As further shown, the communication management resource 140 produces the interference values or cross pole discrimination (ANT1_Avg_CPD) information associated with the antenna hardware type #1 via a logarithmic averaging of the values in column 921 and the values in column 922. For example, for the position M1 associated with antenna hardware type #1, the communication management resource produces the average interference value 16.6 based upon the logarithmic average of 9.11 and 19.2; for the position M2 associated with antenna hardware type #1, the communication management resource produces the average interference value 21.6 based upon the logarithmic average of 24 and 15.8; for the position M3 associated with antenna hardware type #1, the communication management resource produces the average interference value 13.61 (cross pole discrimination) based upon the logarithmic average of 16.52 and 0.2; for the position M4 associated with antenna hardware type #1, the communication management resource produces the average interference value 12.89 (cross pole discrimination) based upon the logarithmic average of 2.5 and 15.7; and so on.

As previously discussed, the communication management resource 140 uses the antenna test information 122 associated with the antenna hardware type #2 in FIG. 8 to produce the interference information 152 (cross pole discrimination) in FIG. 9.

For example, the communication management resource 141 produces the column 931 based on the difference between component X1 in column 821 and the component Y1 in column 822 for each of the angular positions M1 through M12. Accordingly, the communication management resource 140 produces the value 8.9 for the angular position M1 based on a difference between −26.9 dB and −35.8 dB; the communication management resource 140 produces the value 23.1 for the angular position M2 based on a difference between −24.9 dB and −48 dB; the communication management resource 140 produces the value 14.4 for the angular position M3 based on a difference between −30.6 dB and −45 dB; the communication management resource 140 produces the value 1.5 for the angular position M4 based on a difference between −43.6 dB and −45.1 dB; and so on.

The communication management resource 141 produces the column 932 based on the difference between component X2 in column 823 and the component Y2 in column 824 for each of the angular positions M1 through M12. Accordingly, the communication management resource 140 produces the value 16 for the angular position M1 based on a difference between −23 dB and −39 dB; the communication management resource 140 produces the value 13.2 for the angular position M2 based on a difference between −29.9 dB and −43.1 dB; the communication management resource 140 produces the value 0.5 for the angular position M3 based on a difference between −40.6 dB and −41.1 dB; the communication management resource 140 produces the value 13 for the angular position M4 based on a difference between −38.2 dB and −541.2 dB; and so on.

As further shown, the communication management resource 140 produces the interference values or cross pole discrimination (ANT2_Avg_CPD) information associated with the antenna hardware type #2 via a logarithmic averaging of the values in column 931 and the values in column 932. For example, for the position M1 associated with antenna hardware type #2, the communication management resource produces the average interference value 13.76 (cross pole discrimination) based upon the logarithmic average of 8.9 and 16; for the position M2 associated with antenna hardware type #2, the communication management resource produces the average interference value 20.51 (cross pole discrimination) based upon the logarithmic average of 23.1 and 13.2; for the position M3 associated with antenna hardware type #2, the communication management resource produces the average interference value 11.56 (cross pole discrimination) based upon the logarithmic average of 14.4 and 0.5; for the position M4 associated with antenna hardware type #2, the communication management resource produces the average interference value 10.29 based upon the logarithmic average of 1.5 and 13; and so on.

In one example, the log average ANT1_Avg_CPD and ANT2_Avg_CPD is determined via the following equation:

$$= 10 * LOG 10 [ ( 1 {0}^{PORT 1 / 10} + 1 {0}^{PORT 2 / 10} ) / 2 ] ,$$

where PORT1 is the value in column 921 and PORT2 is the value in column 922 for antenna hardware type #1 and determination of ANT1_Avg_CPD; where PORT1 is the value in column 921 and PORT2 is the value in column 932 for antenna hardware type #2 and determination of ANT2_Avg_CPD.

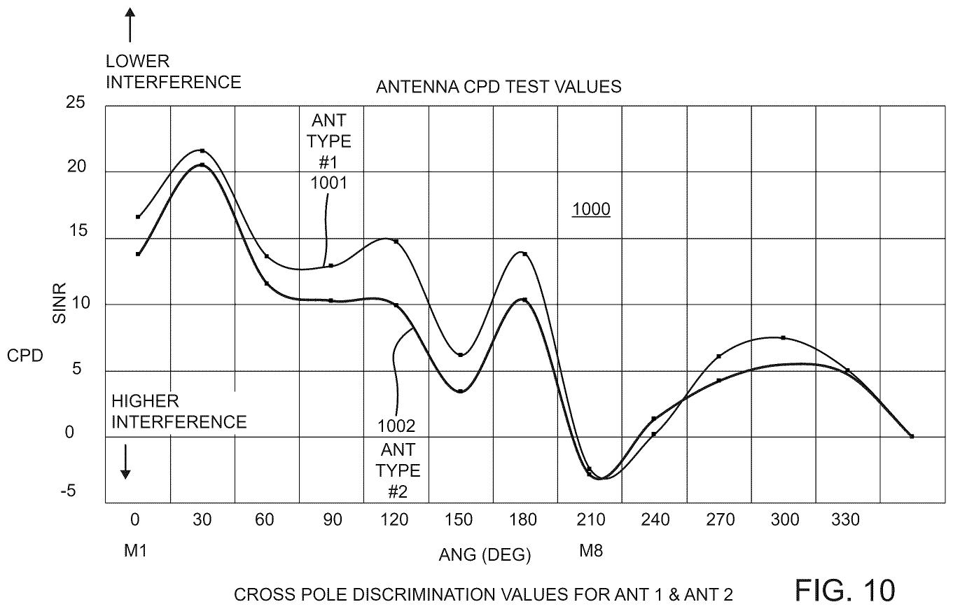

FIG. 10 is an example graph illustrating a plot of cross pole discrimination values (interference) versus angular sector as discussed herein.

Graph 1000 illustrates the signal to interference noise ratio (SINR) on the y-axis (also known as cross pole discrimination values in FIG. 9) associated with each of the different antenna types with respect to the different angles of testing on the x-axis.

For example, curve 1001 for antenna hardware type 1 illustrates the magnitude of the average cross pole discrimination value ANT1_Avg_CPD (or SINR) in FIG. 9 with respect to the corresponding angle MX, where X=1 through 12. More specifically, curve 1001 indicates that the average cross pole discrimination value ANT1_Avg_CPD (or SINR) for sector M1, angle θ, is 16.6 dB; curve 1001 indicates that the average cross pole discrimination value for sector M2, angle 30, is 21.6 dB; curve 1001 indicates that the average cross pole discrimination value ANT1_Avg_CPD (or SINR) for sector M3, angle 60, is 13.6 dB; curve 1001 indicates that the average cross pole discrimination value for sector M4, angle 90, is 12.89 dB; and so on.

Curve 1002 for antenna hardware type 2 illustrates the magnitude of the average cross pole discrimination value ANT2_Avg_CPD in FIG. 9 with respect to the corresponding angle MX, where X=1 through 12. More specifically, curve 1002 indicates that the average cross pole discrimination value for sector M1, angle θ, is 13.76 dB; curve 1002 indicates that the average cross pole discrimination value for sector M2, angle 30, is 20.51 dB; curve 1002 indicates that the average cross pole discrimination value for sector M3, angle 60, is 11.51 dB; curve 1002 indicates that the average cross pole discrimination value for sector M4, angle 90, is 10.29 dB; and so on.

As further discussed herein, the higher values of cross pole discrimination on the Y axis of graph 1000 indicate that there is less wireless interference between the two frequencies carrier frequency CF1 and carrier frequency CF2.

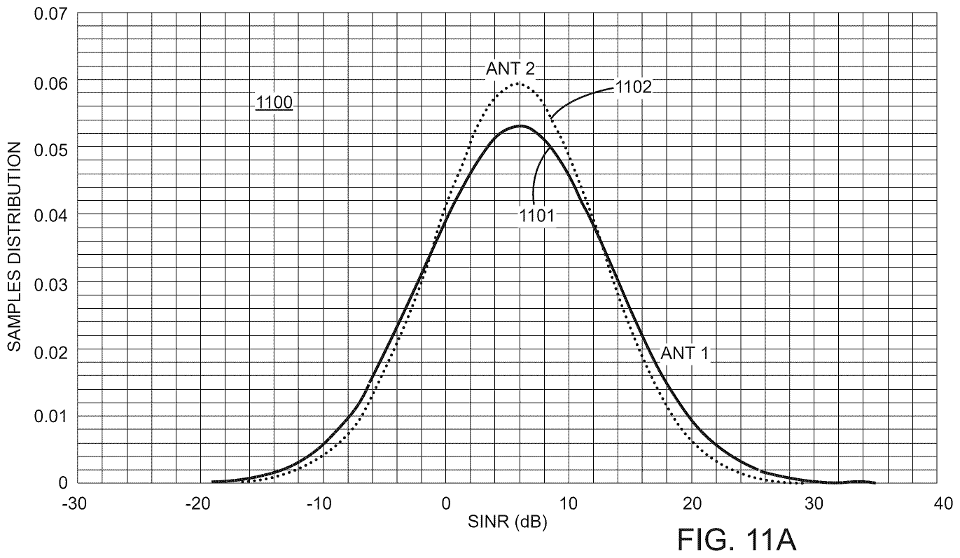

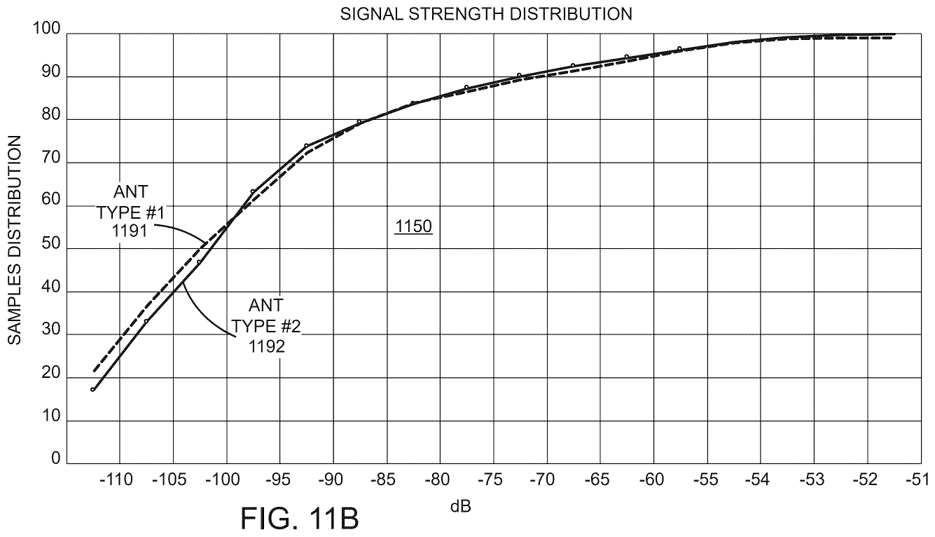

FIG. 11A is an example diagram illustrating interference distribution associated with the first type of antenna hardware and the second type of antenna hardware as discussed herein.

In this example, the communication management resource 140 or other suitable entity produces a respective graph 1100 (such as from the collected information) indicating signal-to-interference-noise ratio (SINR) versus samples distribution associated with operation of each of the antenna hardware type #1 and the antenna hardware type #2.

More specifically, graph 1100 illustrates an interference distribution curve 1101 associated with the antenna hardware type #1 versus antenna distribution curve 1102 associated with the antenna hardware type #2. The graph 1100 and corresponding interference distribution curves illustrate that the antenna hardware type #1 provides better immunity to channel interference (because of better cross pole discrimination) between carrier frequency CF1 and carrier frequency CF2 than the antenna hardware type #2 such as when transmitting wireless signals at multiple different carrier frequencies such as carrier frequency CF1 and carrier frequency CF2 similar to the test setup in FIGS. 2 and 3.

FIG. 11B is an example diagram illustrating interference distribution associated with the first type of antenna hardware and the second type of antenna hardware as discussed herein.

In this example, the communication management resource 140 or other suitable entity produces a respective graph 1150 (signal strength distribution) indicating sample distribution versus decibel associated with operation of each of the antenna hardware type #1 (curve 1191) and the antenna hardware type #2 (curve 1192).

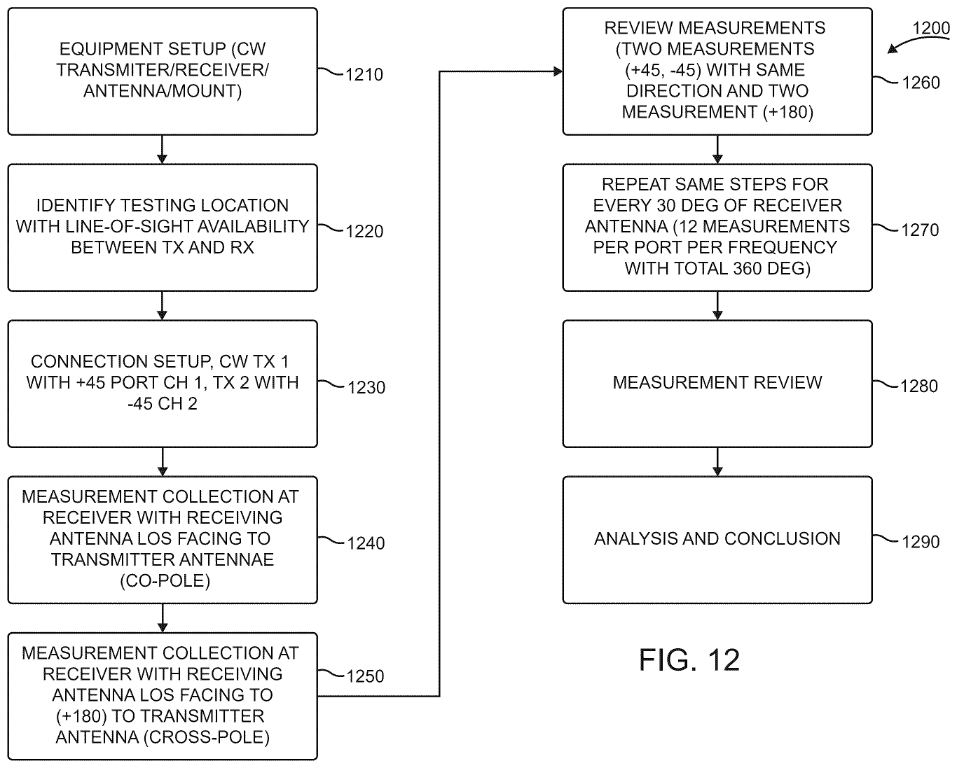

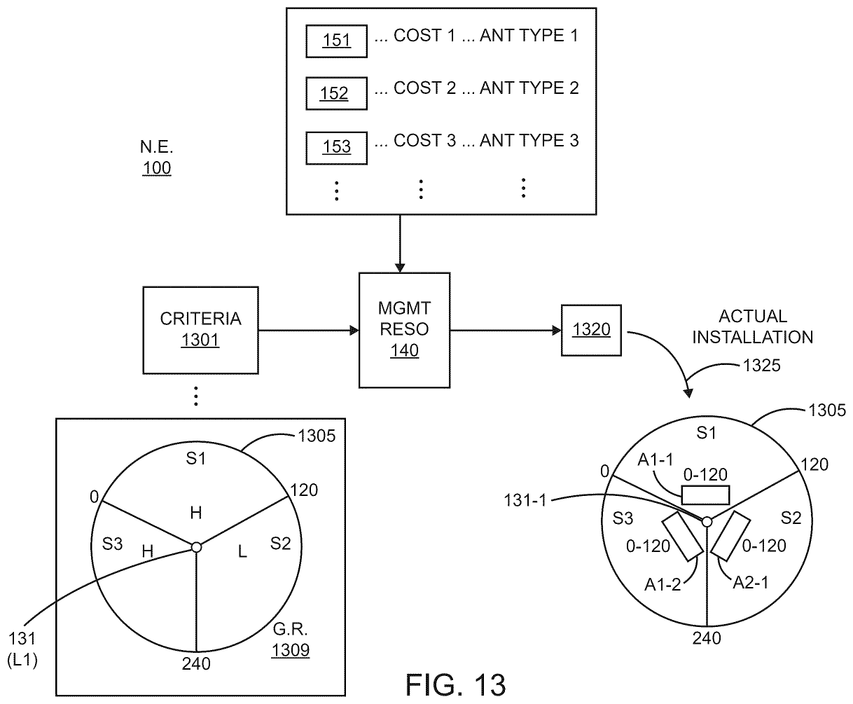

FIG. 12 is an example flow chart illustrating operations of collecting co-pole and cross-pole field measurements and determination of cross pole discrimination as discussed herein.

As previously discussed, and as summarized in flowchart 1200, the wireless network management system 101 and corresponding resources can be configured to analyze different types of antenna hardware as well as perform a measurement review for deployment of the different types of antenna hardware.

For example, in processing operation 1210, the test environment 110-1 and test environment 110-2 are set up to include an instance of antenna hardware under test as well as a receiver 220.

In processing operation 1220, technicians identify testing location with line of sight availability between the antenna hardware under test and a respective receiver 220.

In processing operation 1230, the technicians provide connection setup between the signal generator 210 and the antenna hardware under test.

In processing operation 1240, the technicians perform measuring and collection data via the receiver 220 at different angular positions.

In processing operation 1250, the receiver is used to perform measuring and collection of wireless signals at different angular positions.

In processing operation 1260, the management resource 140 analyzes the obtain measurements.

In processing operation 1270, the technicians repeat the prior operations for each type of antenna hardware for each of the different 30 degree segments.

In processing operation 1280, the communication management resource 140 converts the antenna test information 120 into the corresponding interference information 150 (cross pole discrimination information).

In processing operation 1290, the wireless network management system 101 performs analysis and conclusion of implementing the different instances of antenna hardware in the network environment 100.

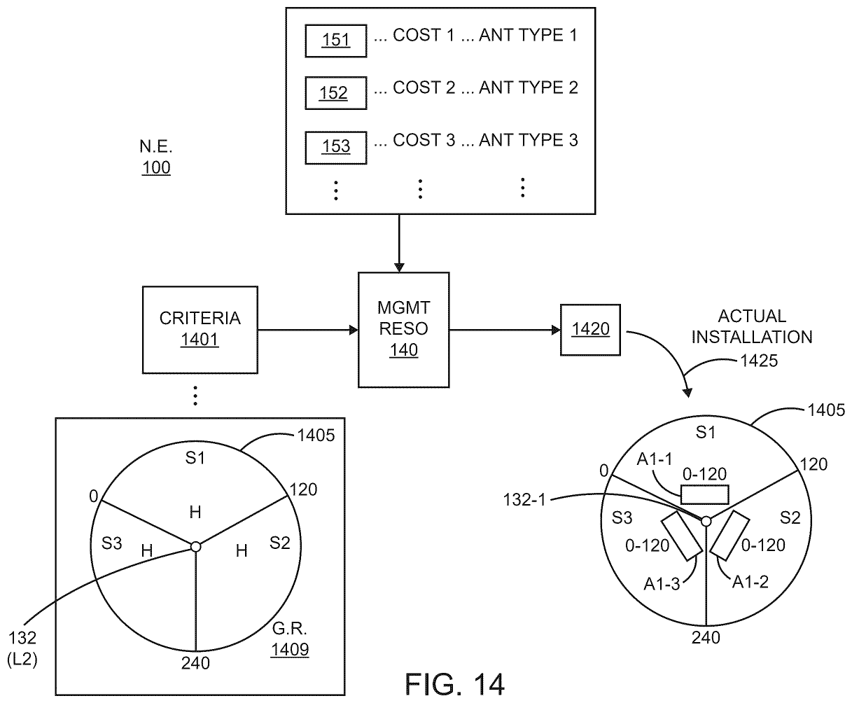

FIG. 13 is an example diagram illustrating receipt of first installation criteria and selection of one or more different types of antenna hardware to implement a corresponding wireless base station as discussed herein.

Subsequent to collection of antenna test information 120 and generation of corresponding interference information 150, the communication management resource 140 or other suitable entity configures a respective wireless network based upon received installation criteria for implementing a respective one or more wireless base station in the network environment 100.

More specifically, in this example, assume that the communication management resource 140 receives installation criteria 1301 indicating a desire to provide wireless services via a region of wireless coverage 1305 in a corresponding geographical region 1309. As shown, providing wireless services in the geographical region 1309 includes installing a new wireless base station 131 at location L1 to provide wireless services to the corresponding sectors S1, S2, and S3.

Assume that each of the sectors S1, S2, and S3 are 120 degrees. In this example, each of the sectors requires a respective instance of antenna hardware to provide the wireless services as indicated by the installation criteria 1301.

Further this example, the base station installation criteria 1301 for installing new wireless base station 131 indicates that sector S1 in the geographical region 1309 between 0 and 120 degrees has a high density of users (such as an expectation that greater than 50 communication devices in the respective sector S1 will simultaneously connect to the wireless base station 131); sector S2 between 120 degrees and 240 degrees has a low density of users (such as an expectation that less than 20 communication devices in the sector S2 will simultaneously connect to the wireless base station 131); sector S3 between 240 degrees and 360 degrees has a high density of users (such as an expectation that greater than 50 communication devices in the sector S3 will simultaneously connect to the wireless base station 131).

A sector including a high density of users requires antenna hardware supporting a high level of cross pole discrimination (lower interference amongst multiple channels #1 and channel #2). A sector including a low density of users requires antenna hardware supporting a low level of discrimination.

As previously discussed, the antenna type #1 provides lower wireless interference (higher cross pole discrimination) and thus better wireless service than the antenna type #2 for the corresponding range between 0 degrees and 120 degrees of the antenna type #1.

As further shown, the cost associated with an instance of the antenna type #1 is COST1 such as $400. The cost associated with an instance of the antenna type #2 is COST2 such as $200.

The communication management resource 140 can be configured to strike a balance between cost and wireless service performance (such as determined from wireless interference as determined from cross pole discrimination values associated with each of the different types of antenna hardware) when choosing different types of antenna for installing the wireless base station 131 in the network environment 100.

For example, as indicated by the criteria 1301, each of the sector S1 and the sector S3 associated with the wireless base station 131 is expected to have a high density of corresponding users above a threshold level attempting to simultaneously connect to the wireless base station 131 in the geographical region 1309. The sector S2 associated with the wireless base station 131 is expected to have only a low density of corresponding users (wireless communication devices) attempting to connect to the wireless base station 131 in the geographical region 1309.

In such an instance, to provide good wireless service which outweighs antenna costs in sectors S1 and S3 (meaning that the higher cost for antenna hardware type #1 is acceptable), the communication management resource 140 or other suitable entity selects a first instance of the antenna hardware #1 (providing higher cross pole discrimination than antenna hardware type #2 for the main lobe 0 through 120 degrees) for installation in the sector S1; the communication management resource 140 or other suitable entity selects a second instance of the antenna hardware #1 for installation in the sector S3. To save on costs, because the more expensive antenna hardware type #1 is not needed for the low density of users in sector S2 (because only and antenna hardware having a lower cross pole discrimination is needed), the communication management resource 140 selects a first instance of antenna type #2 for implementing in the sector S2 instead of the more expensive antenna hardware type #1 because the latter provides no advantage over antenna hardware type #2.

In such an instance, the management resource 140 produces the implementation information 1320 to specify: i) the deployment 1325 of the new physical wireless base station 131-1 in the network environment 100 includes orienting the first instance A1-1 of the antenna hardware type #1 such that the 0 through 120 degree range (determined to be the main lobe) of the antenna hardware type #1 wirelessly services (transmits) in the sector S1 between 0 through 120 degrees range of the range of wireless coverage 1305; ii) the deployment 1325 of the physical wireless base station 131-1 in the network environment 100 includes orienting the first instance A2-1 of the antenna hardware type #2 such that the 0 through 120 degree range (determined to be the main lobe) of the antenna hardware type #2 wirelessly services (transmits) the sector S2 between 120 through 240 degrees range of the range of wireless coverage 1305; iii) the deployment 1325 of the physical wireless base station 131-1 in the network environment 100 includes orienting the second instance A1-2 of the antenna hardware type #1 such that the 0 through 120 degree range (determined to be the main lobe) of the antenna hardware type #1 wirelessly services (transmits) the sector S3 between 240 through 360 degrees range of the range of wireless coverage 1305.

FIG. 14 is an example diagram illustrating receipt of second installation criteria and selection of one or more different types of antenna hardware to implement a corresponding wireless base station as discussed herein.

As previously discussed, subsequent to collection of antenna test information 120 and generation of corresponding interference information 150, the communication management resource 140 or other suitable entity configures a respective wireless network based upon received criteria for implementing a respective one or more wireless base station in the network environment 100.

More specifically, in this example, assume that the communication management resource 140 receives installation criteria 1401 indicating a desire to provide wireless services via a region of wireless coverage 1405 in a corresponding geographical region 1409. As shown, providing wireless services in the geographical region 1409 includes installing a new wireless base station 132 at location L2 to provide wireless services to the corresponding sectors S1, S2, and S3 associated with region of wireless coverage 1405.

Assume that each of the sectors S1, S2, and S3 associated with the region of wireless coverage 1405 are 120 degrees.

The criteria 1401 for installing any wireless base station 132 indicates that sector S1 in the geographical region 1409 between 0 and 120 degrees has a high density of users (such as an expectation that greater than 50 communication devices in the respective sector S1 will simultaneously connect to the wireless base station 131); sector S2 between 120 degrees and 240 degrees has a high density of users (such as an expectation that greater than 50 communication devices in the sector S2 will simultaneously connect to the wireless base station 131); sector S3 between 240 degrees and 360 degrees has a high density of users (such as an expectation that greater than 50 communication devices in the sector S3 will simultaneously connect to the wireless base station 131).

As previously discussed, the antenna type #1 provides lower wireless interference and thus better wireless service than the antenna type #2 for the corresponding range between 0 degrees and 120 degrees of the antenna type #1.

As further shown, the cost associated with an instance of the antenna type #1 is COST1 such as $400. The cost associated with an instance of the antenna type #2 is COST2 such as $200.

The communication management resource 140 can be configured to strike a balance between cost and wireless service performance (such as determined from wireless interference associated with each of the different types of antenna hardware) when choosing different types of antenna for installing the wireless base station 132 and corresponding antenna hardware in the network environment 100.

For example, as indicated by the criteria 1401, each of the sector S1, sector S2, and the sector S3 associated with the wireless base station 132 is expected to have a high density of corresponding users above a threshold level attempting to simultaneously connect to the wireless base station 131 in the geographical region 1409.

In such an instance, to provide good wireless service which outweighs antenna costs in all of the sectors S1, S2, and S3, the communication management resource 140 or other suitable entity selects a first instance A1-1 of the antenna hardware #1 for installation in the sector S1; the communication management resource 140 or other suitable entity selects a second instance A1-2 of the antenna hardware #1 for installation in the sector S2; the communication management resource 140 or other suitable entity selects a third instance A1-3 of the antenna hardware #1 for installation in the sector S3. It is more important in this case to provide good wireless service to many communication devices than save on costs associated with the respective different types of antennas.

In such an instance, the management resource 140 produces the implementation information 1420 to specify that: i) the deployment 1425 of the physical wireless base station 132-1 in the network environment 100 includes orienting the first instance A1-1 of the antenna hardware type #1 such that the 0 through 120 degree range of the antenna hardware type #1 wirelessly services (transmits) the sector S1 of the region of wireless coverage 1405; ii) the deployment 1425 of the physical wireless base station 132-1 in the network environment 100 includes orienting the second instance A1-2 of the antenna hardware type #1 such that the 0 through 120 degree range of the antenna hardware type #1 wirelessly services (transmits) the sector S2 of the region of wireless coverage 1405; iii) the deployment 1425 of the physical wireless base station 132-1 in the network environment 100 includes orienting the first instance A1-3 of the antenna hardware type #1 such that the 0 through 120 degree range of the antenna hardware type #1 wirelessly services (transmits) the sector S3.

Alternatively, if the amount of wireless service to be provided in the different sectors associated with the region of wireless coverage 1405 is low because it is a rural area, then the first instance of the antenna hardware, second instance of the antenna hardware, and the third instance of the antenna hardware all can be implemented as antenna hardware type #2 because such antennas provide sufficient wireless services at a lower cost savings of $600.

Thus, with reference to FIG. 1 and other FIGS., examples herein include the communication management resource 140 or other suitable entity receiving antenna test information 120 derived based on testing simultaneous transmission of a first wireless carrier frequency CF1 and a second wireless carrier frequency CF2 from each of multiple different types of antenna hardware. Via the antenna test information 120, the management resource 140 determines wireless interference (signal discrimination as previously discussed) associated with each of the multiple different types of antenna hardware transmitting the first wireless carrier frequency and the second wireless carrier frequency. The communication management resource 140 or other suitable entity then configures a wireless base station in the network environment 100 with one or more of the multiple different types of antenna hardware based upon the determined wireless interference.

Further, as previously discussed, the communication management resource can be configured to select a first type of antenna hardware of the multiple different types of antenna hardware based on the determined wireless interference (channel discrimination).

The communication management resource then implements the first type of antenna hardware in a first wireless base station in the network environment. The antenna test information 120 includes first antenna test information 121 associated with a first type of antenna hardware; the antenna test information 120 includes second antenna test information 122 associated with a second type of antenna hardware of the multiple different types of antenna hardware. Selection amongst the multiple different types of antenna hardware may include the communication management resource or other suitable entity: i) selecting the first type of antenna hardware for implementing in the first wireless base station based on first wireless interference (via cross channel signal discrimination information) determined from the first antenna information, and ii) selecting the second type of antenna hardware for implementing in the wireless base station based on a second wireless interference (via cross channel signal discrimination information) determined from the second antenna information.

As previously discussed, antenna hardware cost may be used as a basis to implement one or more different types of antenna hardware. For example, the communication management resource 140 or other suitable entity can be configured to receive cost information indicating a respective cost associated with each of the multiple different types of antenna hardware. For example, the cost associated with the first antenna hardware type #1 is $400; the cost associated with the second antenna hardware type #2 is $200.

Deployment of the multiple different types of antenna hardware includes the communication management resource 140 or other suitable entity selecting amongst the multiple different types of antenna hardware to implement in a wireless base station based upon a combination of the respective cost and respective wireless interference (multiple channel signal discrimination) associated with each the multiple different types of antenna hardware. Typically, the higher cost first antenna hardware type #1 is implemented in regions (sectors) where there is a high demand for service above a threshold level; the lower cost first antenna hardware type #2 is implemented in regions (sectors) where there is a low demand for service below a threshold level.

As previously discussed, in one example, the determined wireless interference is based on determined cross pole discrimination information indicating the degree to which the different types of antenna hardware are immune from wireless and parents.

Further, as previously discussed, the antenna test information 120 captures wireless radiation patterns and corresponding gain supported by the multiple different types of antenna hardware. Configuration of the network environment by the communication management resource 140 or other suitable entity includes: i) receiving installation criteria indicating desired wireless coverage to be provided by installation of a new wireless access point in a geographical region, and ii) based on applying the installation criteria to the wireless radiation patterns of the multiple different types of antenna hardware, assigning a first type of antenna hardware to implement the new wireless access point.

In a further example, the first antenna information 121 indicates a first wireless radiation pattern provided by the first type of antenna hardware #1; the second antenna information 122 indicates a second wireless radiation pattern provided by a second type of second antenna hardware #2. Application of the installation criteria as previously discussed may include the communication management resource 140 or other suitable entity determining a degree to which the first wireless radiation pattern provided by the first antenna hardware supports the desired wireless coverage as indicated by the installation criteria; and determining a degree to which the second wireless radiation pattern provided by the second antenna hardware supports the desired wireless coverage as indicated by the installation criteria. The communication management resource or other suitable entity then selects amongst the multiple different types of antenna hardware to implement in the network environment and corresponding base station 131 such that the selected type of antenna hardware provides the desired wireless coverage as specified by the installation criteria.

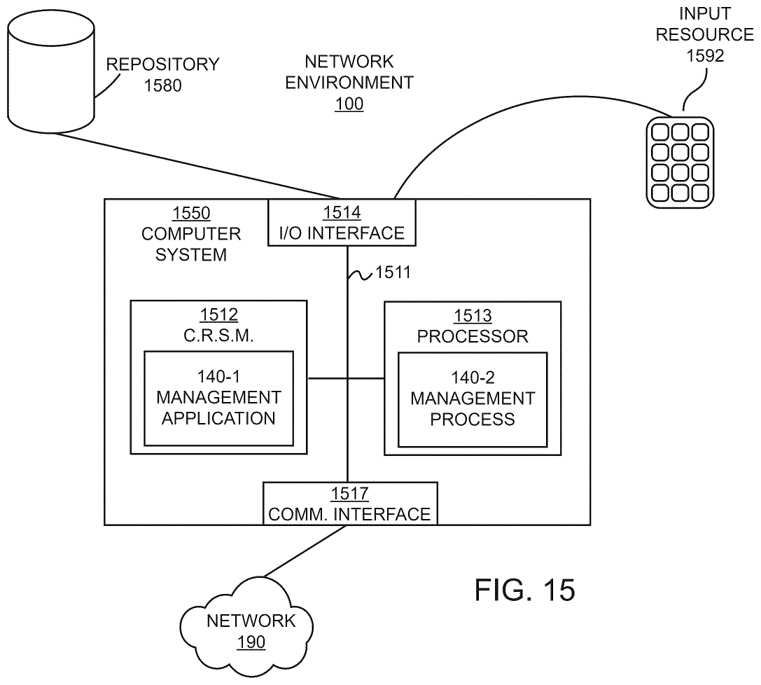

FIG. 15 is an example block diagram of a computer system for implementing any of the operations as discussed herein.

Note that any of the resources (such as communication management resource 140, etc.) as discussed herein can be configured to include computer processor hardware and/or corresponding executable instructions to carry out the different operations as discussed herein.

For example, as shown, computer system 1550 of the present example includes interconnect 1511 coupling computer readable storage media 1512 such as a non-transitory type of media (which can be any suitable type of hardware storage medium in which digital information can be stored and or retrieved), a processor 1513 (computer processor hardware), I/O interface 1514, and a communications interface 1517.

I/O interface(s) 1514 supports connectivity to repository 1580 and input resource 1592.

Computer readable storage medium 1512 can be any hardware storage device such as memory, optical storage, hard drive, floppy disk, etc. In one example, the computer readable storage medium 1512 is computer readable storage hardware that stores instructions and/or data.

As shown, computer readable storage media 1512 can be encoded with management application 140-1 (e.g., including instructions) in a respective wireless station to carry out any of the operations as discussed herein.

During operation of one example, processor 1513 accesses computer readable storage media 1512 via the use of interconnect 1511 in order to launch, run, execute, interpret or otherwise perform the instructions in management application 140-1 stored on computer readable storage medium 1512. Execution of the management application 140-1 (configuration management application) produces management process 140-2 (configuration management process) to carry out any of the operations and/or processes as discussed herein.

Those skilled in the art will understand that the computer system 1550 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1550 may reside at any location or can be included in any suitable resource in any network environment to implement functionality as discussed herein.

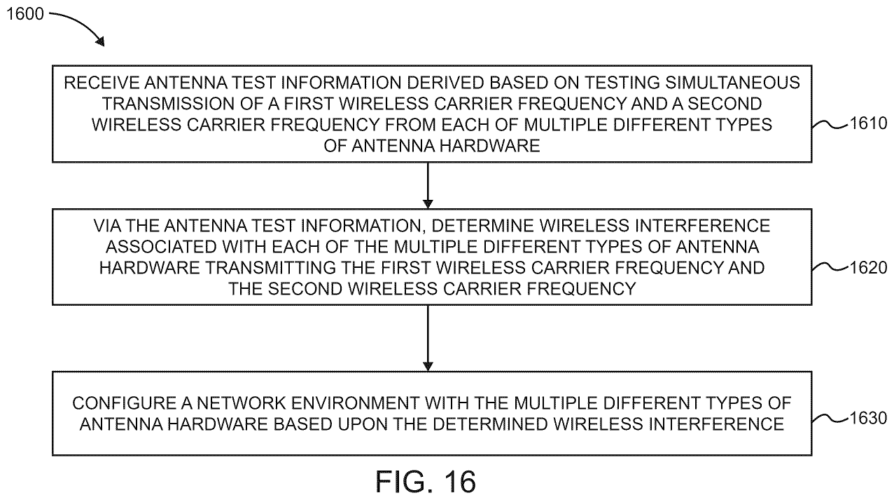

Functionality supported by the different resources will now be discussed via the flowchart in FIG. 16. Note that the steps in the flowcharts below can be executed in any suitable order.

FIG. 16 is a flowchart 1600 illustrating an example method according to examples herein. Note that there will be some overlap with respect to concepts as discussed above because the flowchart 900 captures the general ideas as previously presented.

In processing operation 1610, the communication management resource 140 receives antenna test information 110 derived based on testing simultaneous transmission of a first wireless carrier frequency and a second wireless carrier frequency from each of multiple different types of antenna hardware.

In processing operation 1620, the communication management resource 140 uses the antenna test information 120 to determine wireless interference (via interference information 150 or cross pole discrimination information) associated with each of the multiple different types of antenna hardware.

In processing operation 1630, the communication management resource 140 configures the network environment 100 with the multiple different types of antenna hardware based upon the determined wireless interference.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
receiving antenna test information derived based on testing simultaneous transmission of a first wireless carrier frequency and a second wireless carrier frequency from each of multiple different types of antenna hardware;
via the antenna test information, determining wireless interference associated with each of the multiple different types of antenna hardware transmitting the first wireless carrier frequency and the second wireless carrier frequency; and
configuring a network environment with the multiple different types of antenna hardware based upon the determined wireless interference.

2. The method as in claim 1, wherein configuring a network environment with the multiple different types of antenna hardware includes:
based on the determined wireless interference, selecting a first type of antenna hardware of the multiple different types of antenna hardware; and
implementing the first type of antenna hardware in a first wireless base station in the network environment.

3. The method as in claim 2, wherein the antenna test information includes first antenna test information associated with a first type of antenna hardware of the multiple different types of antenna hardware;
wherein the antenna test information includes second antenna test information associated with a second type of antenna hardware of the multiple different types of antenna hardware; and
wherein selecting amongst the multiple different types of antenna hardware includes: i) selecting the first type of antenna hardware for implementing in the first wireless base station based on first wireless interference determined from the first antenna information, and ii) selecting the second type of antenna hardware for implementing in the wireless base station based on a second wireless interference determined from the second antenna information.

4. The method as in claim 1, wherein the antenna test information includes:
first antenna test information derived from testing a first type of antenna hardware of the multiple different types of antenna hardware; and
second antenna test information derived from testing a second type of antenna hardware of the multiple different types of antenna hardware.

5. The method as in claim 4, wherein the first antenna test information includes first measurements generated by a receiver antenna simultaneously receiving the first wireless carrier frequency and the second wireless carrier frequency transmitted from the first type of antenna hardware; and
wherein the second antenna test information includes second measurements generated by the receiver antenna simultaneously receiving the first wireless carrier frequency and the second wireless carrier frequency transmitted from the second type of antenna hardware.

6. The method as in claim 5, wherein the first measurements are based on the receiver antenna receiving the first wireless carrier frequency and the second wireless carrier frequency transmitted at multiple different angular directions from the first type of antenna hardware; and
wherein the second measurements are based on the receiver antenna receiving the first wireless carrier frequency and the second wireless carrier frequency transmitted at multiple different angular directions from the second type of antenna hardware.

7. The method as in claim 1, wherein utilizing the antenna test information to determine wireless interference includes:
determining wireless interference associated with each of the multiple different types of antenna hardware for different angular directions.

8. The method as in claim 1 further comprising:
receiving cost information indicating a respective cost associated with each of the multiple different types of antenna hardware; and
wherein deploying the multiple different types of antenna hardware includes: selecting amongst the multiple different types of antenna hardware to implement in a wireless base station based upon a combination of the respective cost and respective wireless interference associated with each the multiple different types of antenna hardware.

9. The method as in claim 1, wherein the determined wireless interference is cross pole discrimination information.

10. The method as in claim 1, wherein the antenna test information captures wireless radiation patterns supported by the multiple different types of antenna hardware; and
wherein configuring a network environment with the multiple different types of antenna hardware includes: i) receiving installation criteria indicating desired wireless coverage to be provided by installation of a new wireless access point in a geographical region, and ii) based on applying the installation criteria to the wireless radiation patterns of the multiple different types of antenna hardware, assigning a first type of antenna hardware to implement the new wireless access point.

11. The method as in claim 10, wherein receiving the antenna test information includes:
receiving first antenna information indicating a first wireless radiation pattern provided by the first type of antenna hardware; and
receiving second antenna information indicating a second wireless radiation pattern provided by a second type of second antenna hardware.

12. The method as in claim 11, wherein applying the installation criteria includes:
determining a degree to which the first wireless radiation pattern provided by the first antenna hardware supports the desired wireless coverage as indicated by the installation criteria; and
determining a degree to which the second wireless radiation pattern provided by the second antenna hardware supports the desired wireless coverage as indicated by the installation criteria.

13. A system comprising:
management hardware operative to:
receive antenna test information derived based on testing simultaneous transmission of a first wireless carrier frequency and a second wireless carrier frequency from each of multiple different types of antenna hardware;
via the antenna test information, determine wireless interference associated with each of the multiple different types of antenna hardware transmitting the first wireless carrier frequency and the second wireless carrier frequency; and
configure a network environment with the multiple different types of antenna hardware based upon the determined wireless interference.

14. The system as in claim 13, wherein the communication management hardware is further operative to:
based on the determined wireless interference, select a first type of antenna hardware of the multiple different types of antenna hardware; and
implement the first type of antenna hardware in a first wireless base station in the network environment.

15. The system as in claim 13, wherein the antenna test information includes first antenna test information associated with a first type of antenna hardware of the multiple different types of antenna hardware;
wherein the antenna test information includes second antenna test information associated with a second type of antenna hardware of the multiple different types of antenna hardware; and
wherein the communication management hardware is further operative to: i) select the first type of antenna hardware for implementing in the first wireless base station based on first wireless interference determined from the first antenna information, and ii) select the second type of antenna hardware for implementing in the wireless base station based on a second wireless interference determined from the second antenna information.

16. The system as in claim 13, wherein the antenna test information includes:
first antenna test information derived from testing a first type of antenna hardware of the multiple different types of antenna hardware; and
second antenna test information derived from testing a second type of antenna hardware of the multiple different types of antenna hardware.

17. The system as in claim 16, wherein the first antenna test information includes first measurements generated by a receiver antenna simultaneously receiving the first wireless carrier frequency and the second wireless carrier frequency transmitted from the first type of antenna hardware; and
wherein the second antenna test information includes second measurements generated by the receiver antenna simultaneously receiving the first wireless carrier frequency and the second wireless carrier frequency transmitted from the second type of antenna hardware.

18. The system as in claim 13, wherein the first measurements are based on the receiver antenna receiving the first wireless carrier frequency and the second wireless carrier frequency transmitted at multiple different angular directions from the first type of antenna hardware; and
wherein the second measurements are based on the receiver antenna receiving the first wireless carrier frequency and the second wireless carrier frequency transmitted at multiple different angular directions from the second type of antenna hardware.

19. The system as in claim 13, wherein the communication management hardware is further operative to:
determine wireless interference associated with each of the multiple different types of antenna hardware for different angular directions.

20. The system as in claim 13, wherein the communication management hardware is further operative to:
receive cost information indicating a respective cost associated with each of the multiple different types of antenna hardware; and
select amongst the multiple different types of antenna hardware to implement in a wireless base station based upon a combination of the respective cost and respective wireless interference associated with each the multiple different types of antenna hardware.

21. The system as in claim 13, wherein the determined wireless interference is cross pole discrimination information.

22. The system as in claim 13, wherein the antenna test information captures wireless radiation patterns supported by the multiple different types of antenna hardware; and
wherein the communication management hardware is further operative to: i) receive installation criteria indicating desired wireless coverage to be provided by installation of a new wireless access point in a geographical region, and ii) based on applying the installation criteria to the wireless radiation patterns of the multiple different types of antenna hardware, select a first type of antenna hardware to implement the new wireless access point.

23. The system as in claim 22, wherein the communication management hardware is further operative to:
receive first antenna information indicating a first wireless radiation pattern provided by the first type of antenna hardware; and
receive second antenna information indicating a second wireless radiation pattern provided by a second type of second antenna hardware.

24. The system as in claim 23, wherein the communication management hardware is further operative to:
determine a degree to which the first wireless radiation pattern provided by the first antenna hardware supports the desired wireless coverage as indicated by the installation criteria; and
determine a degree to which the second wireless radiation pattern provided by the second antenna hardware supports the desired wireless coverage as indicated by the installation criteria.

25. Computer-readable storage hardware having instructions stored thereon, the instructions, when carried out by computer processor hardware, cause the computer processor hardware to:
receive antenna test information derived based on testing simultaneous transmission of a first wireless carrier frequency and a second wireless carrier frequency from each of multiple different types of antenna hardware;
via the antenna test information, determine wireless interference associated with each of the multiple different types of antenna hardware transmitting the first wireless carrier frequency and the second wireless carrier frequency; and
configure a network environment with the multiple different types of antenna hardware based upon the determined wireless interference.
